(19) United States
(12) Patent Application Publication
(10) Pub. No.: US 2013/0194076 A1
(43) Pub. Date: Aug. 1, 2013

(54) Process Monitoring System and Related Method

(71) Applicants: Yu-Min Ho, Hsinchu (TW); Yen-Liang Wu, Hsinchu (TW)

(72) Inventors: Yu-Min Ho, Hsinchu (TW); Yen-Liang Wu, Hsinchu (TW)

(21) Appl. No.: 13/361,915

(22) Filed: Jan. 30, 2012

(51) Int. Cl. H04Q 5/22

(52) U.S. Cl. 340/10.4

(57) ABSTRACT

A process monitoring system comprises a radio frequency identification (RFID) tag disposed on a position corresponding to the component for receiving a radio-frequency (RF) signal and responding a corresponding feedback signal during a stage of the manufacturing process, an RFID reader transmitting the RF signal and receiving the feedback signal during the stage of the manufacturing process, and a determination module coupled to the RFID reader for determining a duration of the stage according to reception of the feedback signal.

### BACKGROUND OF THE INVENTION

1. Field of the Invention

The present invention relates to a process monitoring system, and more specifically, to a process monitoring system for monitoring a manufacturing process, so as to enhance the efficiency of the manufacturing process.

2. Description of the Prior Art

Supply chain management (SCM) is a discipline related to management of planning, manufacturing and operations necessary to bring a product to the market, from the sourcing of materials to the delivery of completed products. The SCM is a complex field encompassing every process involved in manufacturing a product, and monitoring the manufacturing processes is one major part of the SCM.

One most widely utilized method for monitoring the manufacturing processes is to use barcodes. A barcode is an optical machine-readable representation of data, which shows data about an object to which it attaches. A commonly used barcode is formed by parallel vertical bars arranged as a horizontal strip, which can be scanned by a special optical scanner called barcode reader. To monitor manufacturing processes, barcodes are attached to products or elements, such that a manufacturing system can keep tracks of the products or elements. However, barcodes have at least the following disadvantages for manufacturing process: barcodes are easily damaged or tainted; distance for accurately scanning barcodes is limited; and line-of-sight scanning is required. Therefore, barcodes have limitations for monitoring manufacturing processes.

### SUMMARY OF THE INVENTION

It is therefore a primary objective of the claimed invention to provide a process monitoring system for manufacturing processes of products, in order to improve the efficiency of manufacturing processes.

The present invention discloses a process monitoring system for monitoring a manufacturing process of a component of a device, comprising a radio frequency identification (RFID) tag, disposed on a position corresponding to the component, for receiving a radio-frequency (RF) signal and responding a corresponding feedback signal during a stage of the manufacturing process; an RFID reader, for transmitting the RF signal and receiving the feedback signal during the stage of the manufacturing process; and a determination module, coupled to the RFID reader, for determining a duration of the stage according to reception of the feedback signal.

The present invention further discloses a method for monitoring a manufacturing process of a component of a device, comprising disposing a radio frequency identification (RFID) tag on a position corresponding to the component, for receiving a radio-frequency (RF) signal and responding a corresponding feedback signal during a stage of the manufacturing process; forming an RFID reader, for transmitting the RF signal and receiving the feedback signal during the stage of the manufacturing process; and forming a determination module, coupled to the RFID reader, for determining a duration of the stage according to reception of the feedback signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a process monitoring system according to an embodiment of the present invention.

FIG. 2 is a flowchart diagram of a process monitoring method according to an embodiment of the present invention.

FIG. 3A-FIG. 3D are side-view diagrams of a metallization process according to an embodiment of the present invention.

### DETAILED DESCRIPTION

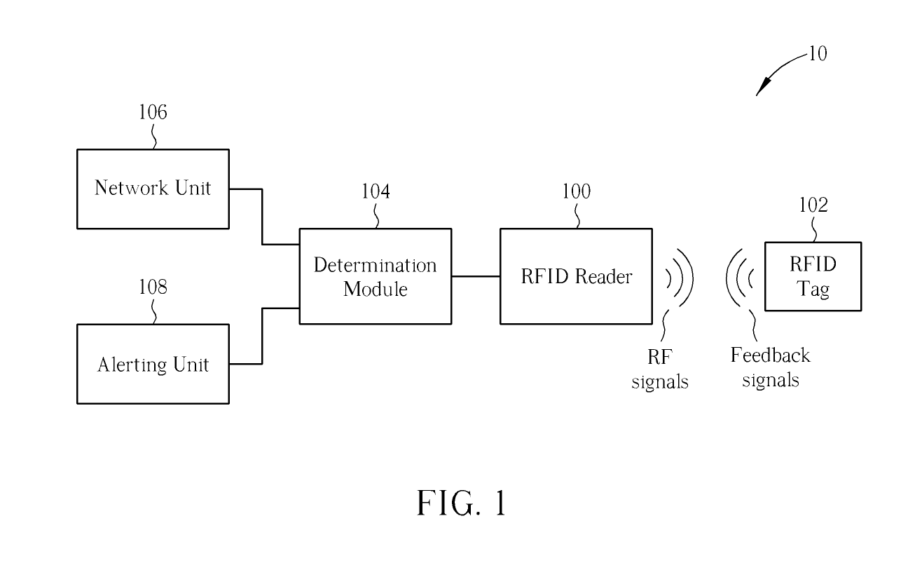

Please refer to FIG. 1, which is a schematic diagram of a process monitoring system 10 according to an embodiment of the present invention. The process monitoring system 10 is used for monitoring a manufacturing process, and includes a radio-frequency identification (RFID) reader 100, an RFID tag 102, a determination module 104, a network unit 106 and an alerting unit 108. The manufacturing process may be a part of or the whole process for manufacturing a component. As shown in FIG. 1, the RFID reader 100 is used for transmitting electromagnetic interrogation radio-frequency (RF) signals to the RFID tag 102, and receiving feedback signals from the RFID tag 102. In detail, the RFID tag 102 can generate a current by electromagnetic induction when receiving the RF signals generated by the RFID reader 100, so as to activate a chip in the RFID tag 102, and generate the feedback signals accordingly. The determination module 104 is used for monitoring signal transmission between the RFID reader 100 and the RFID tag 102, and determining whether the manufacturing process is correct accordingly. For example, the RFID tag 102 can be attached to the component. By continuously detecting the feedback signals from the RFID tag 102, the determination module 104 can verify if the manufacturing process meets an expected result. In detail, when a distance between the RFID reader 100 and the RFID tag 102 is too far, the RFID reader 100 is expected to be incapable of receiving the feedback signals from the RFID tag 102, indicating that the component is not in a scanning area the RFID reader 100; otherwise, the RFID reader 100 is expected to be capable of receiving the feedback signals. Therefore, the determination module 104 can determine a duration of a stage that the component is in (or not in) the scanning area of the RFID reader 100, and verify if the manufacturing process is correct by comparing the duration of the stage to the expected result. The network unit 106, which is controlled by the determination module 104, is used for transmitting information (e.g., whether the manufacturing process is correct) to a host. The alerting unit 108, which is also controlled by the determination module 104, is used for issuing an alert according to an event (e.g., the manufacturing process is incorrect).

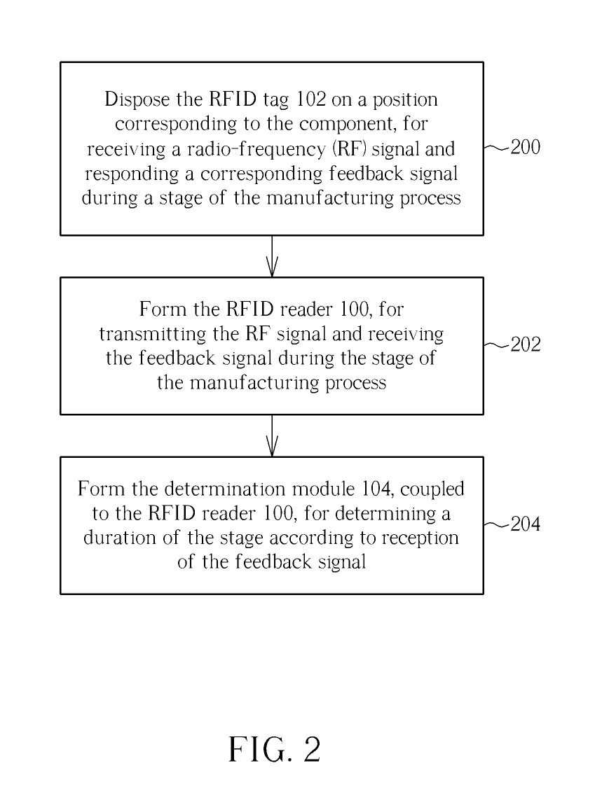

The above operation method can be summarized into FIG. 2, which is a flowchart diagram of a process monitoring process 20 according to an embodiment of the present invention. The process monitoring process 20 is an operation process of the process monitoring system 10, and is used for monitoring a manufacturing process of a component of a device. The process monitoring process 20 includes the following steps:

Step 200: Dispose the RFID tag 102 on a position corresponding to the component, for receiving a radio-frequency (RF) signal and responding a corresponding feedback signal during a stage of the manufacturing process.

Step 202: Form the RFID reader 100, for transmitting the RF signal and receiving the feedback signal during the stage of the manufacturing process.

Step 204: Form the determination module 104, coupled to the RFID reader 100, for determining a duration of the stage according to reception of the feedback signal.

The process monitoring process 20 is a conclusion of the previous description, so the detailed description is omitted herein.

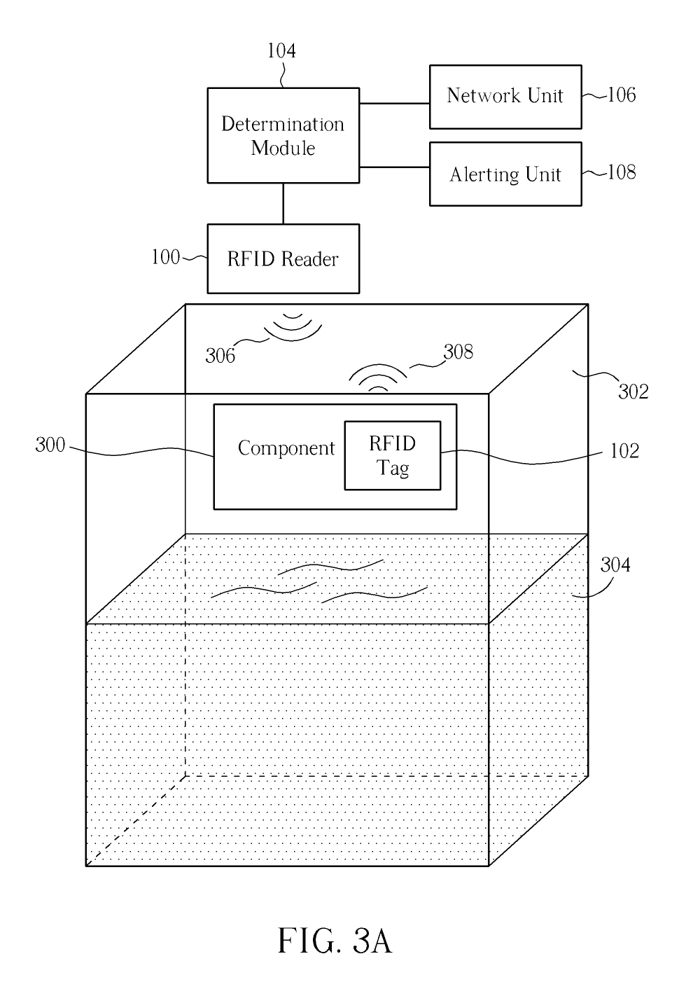

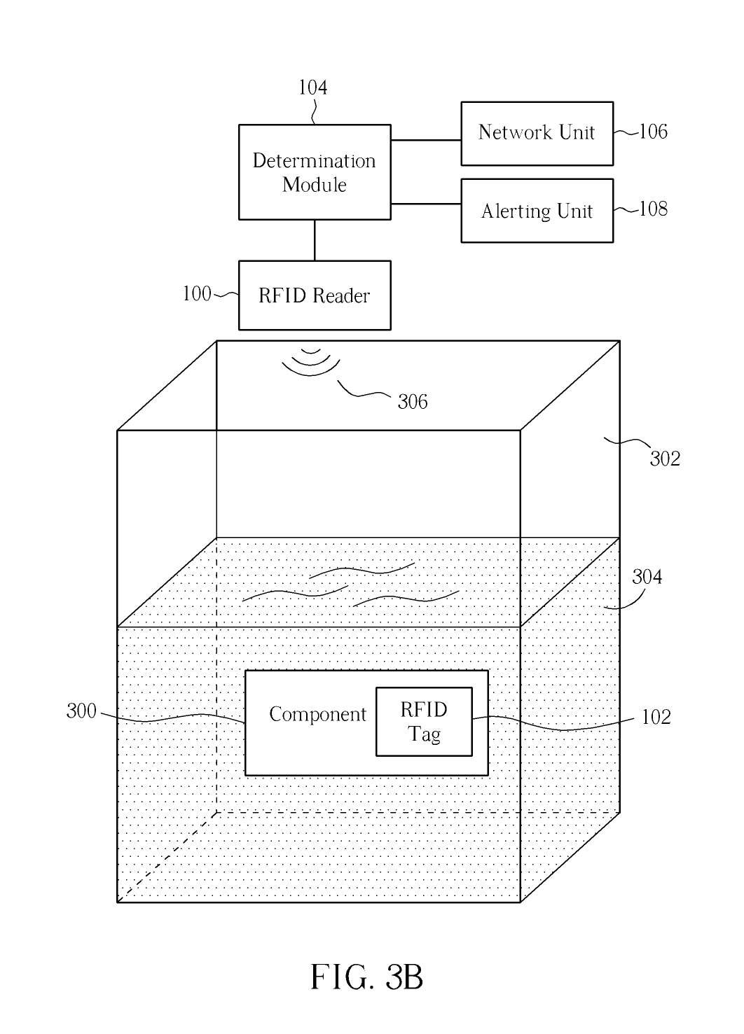

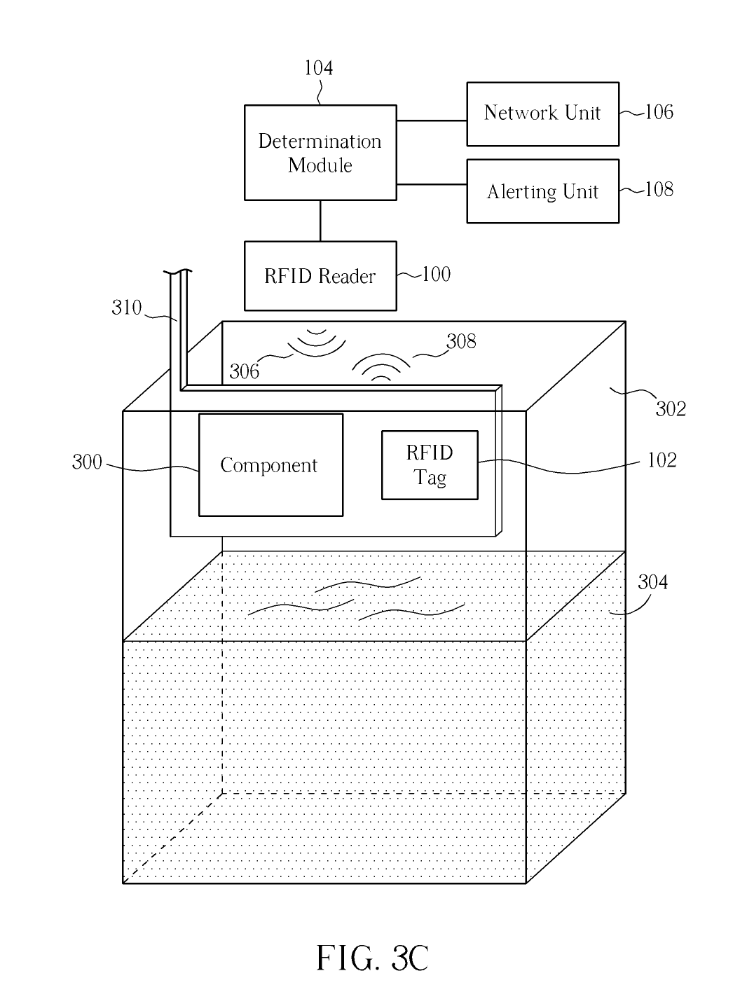

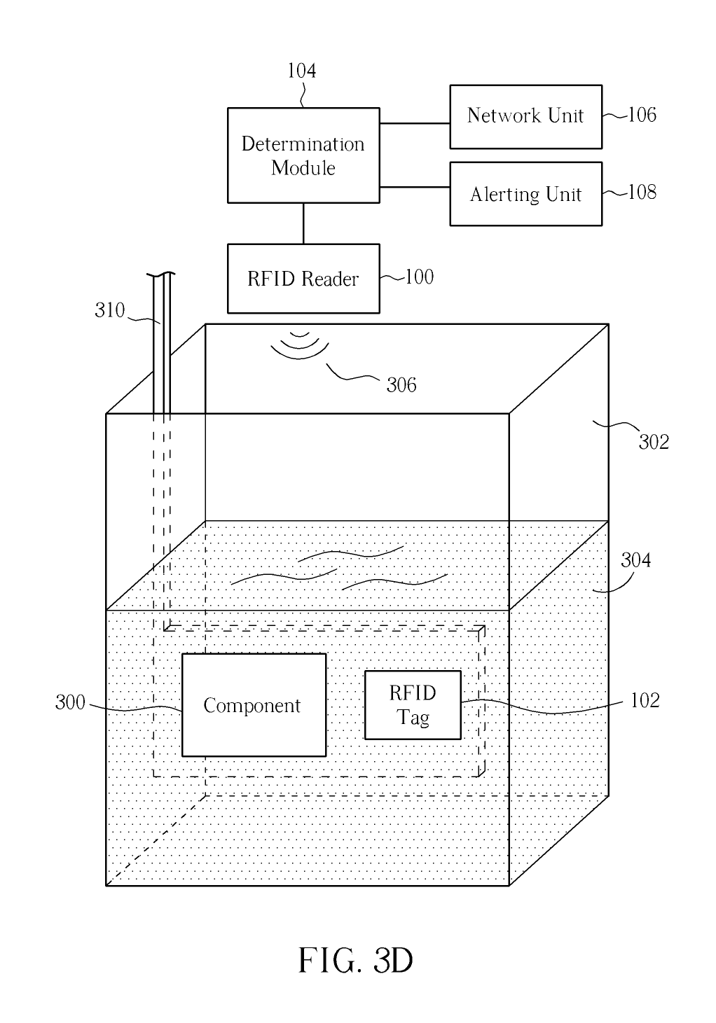

The main spirit of the present invention is to improve the efficiency of manufacturing processes. As such, the process monitoring system 10 and the process monitoring method 20 of the present invention can be utilized for monitoring various manufacturing processes. An embodiment of the manufacturing process is a metallization process. Specifically, please refer to FIG. 3A and FIG. 3A, which are side-view diagrams of a metallization process for metalizing a component 300 of a device with the process monitoring system 10 according to an embodiment of the present invention. In an embodiment, the component 300 is attached with the RFID tag 102, as shown in FIG. 3A and FIG. 3A, and is ready to be immersed into a chemical sink 302 filled with a solution 304. At a stage that the component 300 is not immersed in the chemical sink 302, as illustrated in FIG. 3A, the RFID tag 102 receives an RF signal 306 from the RFID reader 100 and generates a feedback signal 308 accordingly, such that the RFID reader 100 can receive the feedback signal 308 from the RFID tag 102 before the component 300 is immersed in the chemical sink 302. At another stage that the component 300 is immersed in the chemical sink 302, as illustrated in FIG. 3B, the RFID tag 102 cannot receive the RF signal 306 from the RFID reader 100, due to difficulty of transmission through the solution 304. Since the RFID tag 102 cannot receive the RF signal 306, the RFID tag 102 does not generate the feedback signal 308, and therefore the RFID reader 100 does not receive the feedback signal 308. The component 300 is immersed in the chemical sink 302 for a predefined duration. When the metallization process for the component 300 is ended, the component 300 is removed from the chemical sink 302; therefore, the RFID tag 102 receives the RF signal 306 from the RFID reader 100 and transmits the feedback signal 308 to the RFID reader 100 again. As can be seen, the determination module 104 can determine a duration of the stage that the component 300 is not immersed in the chemical sink 302, or the component 300 is immersed in the chemical sink 302 according to whether the RFID reader 100 receives the feedback signal 308 from the RFID tag 102. The determination module 104 can send the duration of each stage via the network unit 106 to the host. Based on comparing the duration of the stage to a predefined duration, the determination module 104 can verify if the metallization process is correct. If the verified result indicates the metallization process is incorrect, the determination module 104 can control the alerting unit 108 to issue an alert, for notifying a staff to take actions.

Furthermore, in another embodiment of the present invention, the RFID tag 102 is disposed on a container 310 containing the component 300, as shown in FIG. 3C and FIG. 3D. Referring to FIG. 3D, at the immersion stage of the component 300, the container 310 is put down so that the component 300 and the RFID tag 102 are immersed in the chemical sink 302. When the metallization process for the component 300 is ended, the container 308 rises so that the component 300 and the RFID tag 102 are removed from the chemical sink 302. The advantages in accordance with the second embodiment are, the RFID tag 102 is disposed on the container 308 instead of on the component 300, and in the end the RFID tag 102 does not have to be removed from the component 300.

Notably, in the present invention, the RFID reader can be disposed on the top of the chemical sink, inside the chemical sink or outside the chemical sink. Preferably, the RFID reader is disposed on the top of the chemical sink, because the RFID reader disposed inside the chemical sink may be affected by the solution, and the RFID reader disposed outside the chemical sink may consume more power due to longer distance between the RFID reader and the RFID tag. However, how to dispose the RFID reader can be modified according to different requirements.

In addition to the metallization process, various processes or applications can apply the process monitoring system of the present invention, for example, oven painting, refrigeration, evaporation, sputtering or ultra-violet electroplating. Using the process monitoring system for monitoring different processes is within the scope of the present invention.

The prior art manufacturing system with barcode technology has the disadvantages of easily damaged or tainted barcodes, short scanning distance, and line-of-sight limitation, affecting the efficiency of manufacturing processes. In comparison, the manufacturing system with the process monitoring system of the present invention provides the advantages of long lifetime for usage, long distance for interrogating, omni-directional transmission and simultaneously interrogating multiple RFID tags.

In conclusion, the process monitoring system of the present invention has the advantages of robust RFID tags, simultaneously multiple RFID tags monitoring, enhancing the efficiency of manufacturing processes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A process monitoring system for monitoring a manufacturing process of a component of a device, comprising:
a radio frequency identification (RFID) tag, disposed on a position corresponding to the component, for receiving a radio-frequency (RF) signal and responding a corresponding feedback signal during a stage of the manufacturing process;
an RFID reader, for transmitting the RF signal and receiving the feedback signal during the stage of the manufacturing process; and
a determination module, coupled to the RFID reader, for determining a duration of the stage according to reception of the feedback signal.

2. The process monitoring system of claim 1, wherein the manufacturing process comprises immersing the component into a chemical sink for a predetermined duration.

3. The process monitoring system of claim 2, wherein the stage is the component not immersed in the chemical sink.

4. The process monitoring system of claim 2, wherein the stage is the component immersed in the chemical sink.

5. The process monitoring system of claim 2, wherein the determination module is further utilized for determining whether the manufacturing process is accurate according to the predetermined duration and the duration of the stage.

6. The process monitoring system of claim 1, further comprising:
a network unit, for transmitting the duration of the stage determined by the determination module to a host.

7. The process monitoring system of claim 1, further comprising:
an alerting unit, for issuing an alert according to the duration of the stage determined by the determination module.

8. The process monitoring system of claim 1, wherein the RFID tag is disposed on the component.

9. The process monitoring system of claim 1, wherein the RFID tag is disposed on a container containing the component.

10. The process monitoring system of claim 1, wherein the manufacturing process is a laser direct structuring (LDS) manufacturing process, and the component is an antenna.

11. A method for monitoring a manufacturing process of a component of a device, comprising:
disposing a radio frequency identification (RFID) tag on a position corresponding to the component, for receiving a radio-frequency (RF) signal and responding a corresponding feedback signal during a stage of the manufacturing process;
forming an RFID reader, for transmitting the RF signal and receiving the feedback signal during the stage of the manufacturing process; and
forming a determination module, coupled to the RFID reader, for determining a duration of the stage according to reception of the feedback signal.

12. The method of claim 11, wherein the manufacturing process comprises immersing the component into a chemical sink for a predetermined duration.

13. The method of claim 12, wherein the stage is the component not immersed in the chemical sink.

14. The method of claim 12, wherein the stage is the component immersed in the chemical sink.

15. The method of claim 12, further comprising determining whether the manufacturing process is accurate according to the predetermined duration and the duration of the stage by the determination module.

16. The process monitoring system of claim 11, further comprising:
forming a network unit, for transmitting the duration of the stage determined by the determination module to a host.

17. The process monitoring system of claim 11, further comprising:
forming an alerting unit, for issuing an alert according to the duration of the stage determined by the determination module.

18. The process monitoring system of claim 11, wherein the RFID tag is disposed on the component.

19. The process monitoring system of claim 11, wherein the RFID tag is disposed on a container containing the component.

20. The process monitoring system of claim 11, wherein the manufacturing process is a laser direct structuring (LDS) manufacturing process, and the component is an antenna.
